(19) United States
(12) Patent Application Publication
(10) Pub. No.: US 2007/0289899 A1
(43) Pub. Date: Dec. 20, 2007

(54) Stacked bed hydrotreating reactor system

(75) Inventors: Kevin Kelly, Friendswood, TX (US); James R. Butler, League City, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/453,360

(22) Filed: Jun. 14, 2006

(51) Int. Cl. C10G 45/00; C10G 17/00; B01J 8/04

(52) U.S. Cl. 208/208 R; 422/190

(57) ABSTRACT

Methods and systems for diesel formation are described herein. The diesel hydrotreating systems generally include a hydrodesulfurization unit having a catalyst system disposed therein and adapted to contact an input stream with the catalyst system therein to form diesel. The catalyst system generally includes a plurality of catalysts including a first catalyst including a hydrodesulfurization catalyst having a first pore diameter and a second catalyst having a second pore diameter, wherein the second pore diameter is larger than the first pore diameter.

### FIELD

Embodiments of the present invention generally relate to hydrocarbon feedstock purification. In particular, embodiments of the invention relate to formation of ultra low sulfur diesel.

### BACKGROUND

It is generally believed that hydrodesulfurization (HDS) catalysts having pores that are larger than necessary lend little to improving diffusional characteristics and as the pore diameters of the catalyst increase, the surface area decreases (at a constant pore volume.) Activity generally decreases with decreases in surface area and loss in pore volume occurs in the smallest diameter pores first. However, such HDS catalysts are generally ineffective at producing ultra low sulfur diesel (ULSD) having a high cut point.

Therefore, a need exists to increase the cut point of ULSD while retaining adequate catalyst activity.

### SUMMARY

Embodiments of the present invention include diesel hydrotreatment systems. The diesel hydrotreatment systems generally include a hydrodesulfurization unit having a catalyst system disposed therein and adapted to contact an input stream with the catalyst system therein to form diesel. The catalyst system generally includes a first catalyst including a hydrodesulfurization catalyst having a first pore diameter and a second catalyst having a second pore diameter, wherein the second pore diameter is larger than the first pore diameter.

Embodiments of the invention further include methods of removing sulfur from a hydrocarbon feedstock. The methods generally include supplying a hydrodesulfurization unit having a catalyst system disposed therein, wherein the catalyst system includes a first catalyst including a hydrodesulfurization catalyst and a second catalyst including a transition catalyst, contacting an input stream including a hydrocarbon feedstock with hydrogen, introducing the input stream into the hydrodesulfurization unit, contacting the input stream with the catalyst system to form an output including diesel and withdrawing the output from the hydrodesulfurization unit.

One or more embodiments include a method of hydrodesulfurization including contacting an input stream including sterically hindered sulfur compounds with a catalyst system to form an output stream including diesel and less than about 15 ppm sulfur, wherein the catalyst system is adapted to remove at least a portion of the sterically hindered sulfur compounds from the input stream.

### BRIEF DESCRIPTION OF DRAWINGS

FIG. 1 illustrates an embodiment of a hydrodesulfurization system.

FIG. 2 illustrates an embodiment of a catalyst system.

FIG. 3 illustrates a plot of effluent sulfur.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

The term “LCO” refers to light FCC cycle gas oil. The term “FCC” refers to fluidized catalytic cracking.

The term “hydrotreating” and “hydrotreatment” (used interchangeably herein) refers to processes used to catalytically stabilize petroleum products and/or remove objectionable elements from products of feedstocks by reacting them with hydrogen. When the process is employed specifically for sulfur removal, the process is referred to herein as “hydrodesulfurization” (HDS.)

The term “cut” refers to that portion of crude oil that boils within certain temperature limits (e.g., ranges), such as limits based on a crude assay true boiling point basis. The term “cut point” refers to a temperature limit of a cut.

The term “straight run diesel” refers to an uncracked diesel fraction distilled from crude oil.

The embodiments described herein generally include methods and processes for feedstream purification in hydrodesulfurization units used to form ultra low sulfur diesel, for example. As used herein, the term “ultra low sulfur diesel” (ULSD) refers to diesel meeting the EPA standard for the sulfur content in diesel fuel sold in the United States. Current standards for ULSD set the allowable sulfur content at 15 ppm.

FIG. 1 illustrates an embodiment of a hydrotreating system 100. The hydrotreating system 100 generally includes at least one hydrodesulfurization unit 102 adapted to receive at least one input stream 104. The HDS unit 102 is further adapted to contact the input stream 104 with a catalyst system 106 to form an output stream 108.

The input stream 104 generally includes a hydrocarbon feedstock. The hydrocarbon feedstock may be derived from crude oil distillation units, such as middle distillate ranges, light distillate ranges, atmospheric gas oil or straight run diesel fuels, cracking units, such as light cycle gas oil or other units involved in oil refining operations, for example. In one embodiment, the hydrocarbon feedstock includes LCO.

The hydrocarbon feedstock may be heated to a temperature of from about 260° C. to about 427° C. and subjected to a pressure of from about 100 psig to about 3,000 psig, for example, prior to entering the HDS unit 102.

The input stream 104 is generally contacted with hydrogen prior to entering the HDS unit 102. Such contact may occur in any manner known to one skilled in the art. For example, the input stream 104 may be contacted with hydrogen at a rate of from about 500 standard cubic feet per barrel (SCFB) to about 3000 SCFB or from about 900 SCFB to about 2600 SCFB of input, for example.

The HDS unit 102 generally includes a reactor with a catalyst system 106 disposed therein. As used herein, the term “catalyst system” collectively refers to one or more catalysts disposed in proximity to one another within a unit.

The catalyst system 106, described in further detail below, may be disposed within the HDS unit 102 by supporting the catalyst system 106 on a bed, for example. The bed design is generally known to one skilled in the art, but may include a perforated or screen type plate, for example.

The HDS unit 102 generally employs a reaction temperature of about 427° C. or less, for example. The weighed average bed temperature (WABT) of the HDS unit 102 may be from about 330° C. to about 415° C., for example. Unexpectedly, the embodiments described herein (and discussed in further detail below) generally result in a lower WABT than systems not employing the embodiments of the invention, such as a WABT that is from about 1° C. to about 5° C. or from about 2° C. to about 3° C. lower, for example.

In one embodiment, the output stream 108 includes ultra low sulfur diesel. For example, the output stream 108 may include diesel having a reduced level of sulfur as compared to the input stream 102. For example, the output stream may include about 15 ppm or less, or about 10 ppm or less or about 5 ppm or less sulfur. In one embodiment, the reaction results in desulfurization of the input stream 102 of at least about 70%, or about 80%, or about 85%, or about 90% or about 95%, for example. Unexpectedly, the embodiments described herein (and discussed in further detail below) generally result in a higher extent of desulfurization than systems not employing the embodiments of the invention, such as an extent of desulfurization that is from about 1% to about 20% greater, for example.

While not described in detail herein, it is known to one skilled in the art that the output stream 108 may be sent for further processing, such as stripping (e.g., to remove hydrogen sulfide), recovered or recycled, for example.

The catalyst system 106 generally includes a HDS catalyst. For example, the HDS catalyst may include a metal oxide, such as nickel oxide, cobalt oxide, molybdenum oxide or combinations thereof, for example.

In addition, the metal oxide may be supported on a support material, such as alumina, silica, silica-alumina, titanium oxide, zirconium oxide, magnesium oxide and combinations thereof, for example.

In one embodiment, the HDS catalyst is a cobalt molybdenum oxide catalyst supported on alumina. For example, the HDS catalyst may include cobalt in a weight ratio of cobalt:molybdenum of from about 6:1 to about 4:1. Further, the HDS catalyst may include from about 2 wt. % to about 10 wt. % cobalt and from about 15 wt. % to about 30 wt. % molybdenum, for example.

In one embodiment, the catalyst system 106 includes a commercially available HDS catalyst, such as DC2318, commercially available from Criterion Catalyst Corp. of Houston, Tex.

The hydrocarbon feedstock generally further includes unwanted components (e.g., objectionable elements), such as sulfur, nitrogen, aromatic compounds or combinations thereof, for example. In one embodiment, the hydrocarbon feedstock includes sulfur containing compounds. The sulfur may be present in the hydrocarbon feedstock in an amount of up to about 2 wt. %, for example.

The sulfur containing compounds may include a variety of compounds. However, the sulfur containing compounds may include sterically hindered sulfur species, which generally require saturation for removal. These species generally lie at the upper cut points (e.g., cut points greater than about 620° F. or from about 620° F. to about 650° F.)

Unfortunately, conventional diesel HDS catalysts have been ineffective at removal of such sterically hindered sulfur species. Therefore, the resulting ULSD may require a cut point that is lower than about 620° F. to meet ULSD specifications, for example.

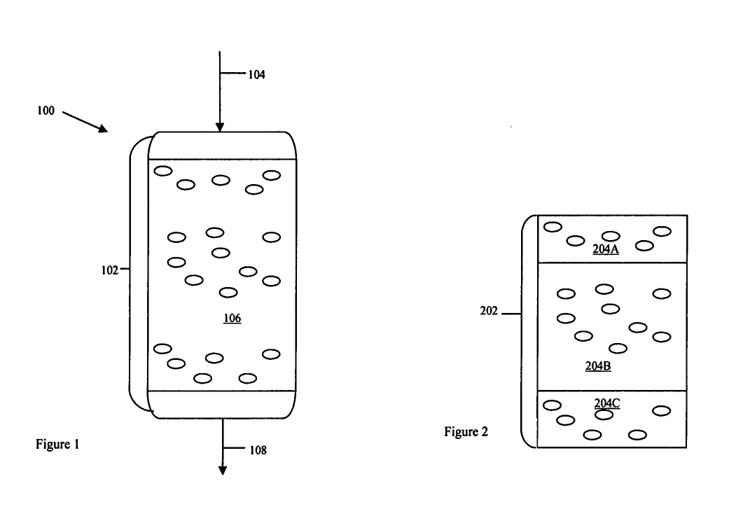

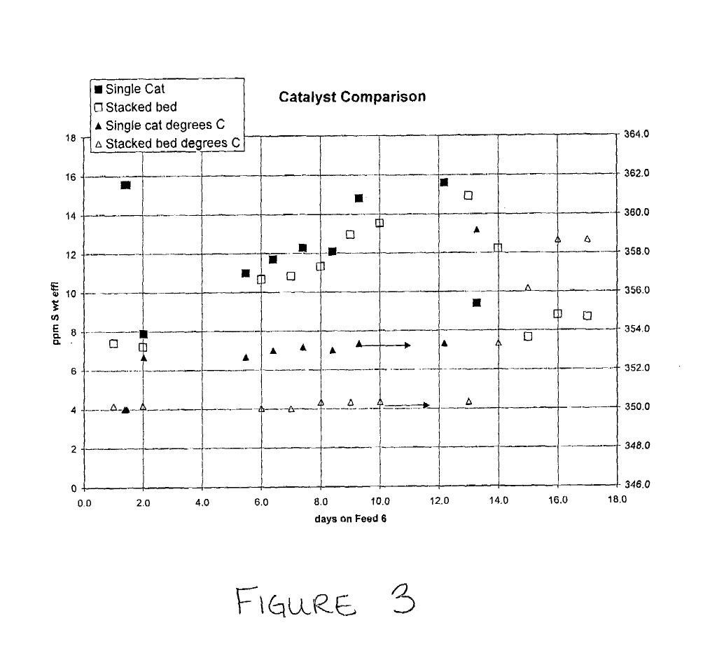

Therefore, the catalyst system 106, a specific embodiment of which is illustrated in further detail in FIG. 2 (see, 202) may include a plurality of catalysts. The number of catalysts may vary from about 1 to about 5 or from about 2 to about 3, for example, which may be disposed within one or more catalyst beds, for example.

FIG. 2 illustrates an embodiment of a catalyst system 202 including three catalyst zones (i.e., a first catalyst zone 204A, a second catalyst zone 204B and a third catalyst zone 204C.) As defined herein, each catalyst zone is generally defined by a location within the unit and includes a single type of catalyst disposed therein. In one or more embodiments, the catalysts generally include two different catalysts.

In one or more embodiments, the first catalyst zone 204A includes a second catalyst, while the second and third catalyst zones 204B and 204C include a first catalyst. The second catalyst may be present in a total amount of from about 10 wt. % to about 30 wt. % or from about 15 wt. % to about 25 wt. % of the total catalyst system weight, for example.

In one or more embodiments, the first and second catalyst zones 204A and 204B include the first catalyst, while the third catalyst zone 204C includes the second catalyst.

In one or more embodiments, the first and third catalyst zones 204A and 204C include the second catalyst, while the second catalyst zone 204B includes the first catalyst. The first and third catalyst zones may include the second catalyst in either substantially equal or varying amounts. The second catalyst may be present in an amount of from about 10 wt. % to about 40 wt. % or from about 25 wt. % to about 35 wt. % of the total catalyst system weight, for example.

It is contemplated that the input stream 102 contact the catalysts within the catalyst system in the order of the embodiments described herein. However, the number of catalyst zones utilized to accomplish such contact may vary and may be greater or less than that described herein. For example, the input stream 102 may first contact the first catalyst and then contact the second catalyst. In one embodiment the first catalyst is disposed within a first catalyst zone and the second catalyst is disposed within a second catalyst zone. Additional second catalyst may optionally be disposed within a third catalyst zone, for example.

In one embodiment, the first catalyst includes the HDS catalysts described above.

The second catalyst includes a large pore catalyst (i.e., a catalyst having a larger pore size than conventional HDS catalysts.) For example, the large pore catalyst may have an average pore diameter that is at least 10%, or at least 20% or at least 25% greater than the average pore diameter of conventional HDS catalysts, for example.

The second catalyst may include a Group VIII metal, such as iron, vanadium, cobalt or nickel, for example. The second catalyst may include the Group VIII metal in an amount of up to about 15 wt. %, for example. The second catalyst may further include a Group VI metal, such as molybdenum or tungsten. The second catalyst may include the Group VI metal in an amount of from about 0.5 wt. % to about 20 wt. %, for example.

In addition, the catalyst may be supported on a high surface area support material, such as alumina, silica, silica-alumina, titanium oxide, zirconium oxide, magnesium oxide and combinations thereof, for example. In one embodiment, the second catalyst includes nickel molybdenum supported on alumina.

Such large pore catalyst may include a transition catalyst, such as a FCC pretreatment catalyst, for example. Further, as described above, the large pore catalyst may include a commercially available transition catalyst, such as RN-412 or DN-3551, commercially available from Criterion Catalyst Corp. of Houston, Tex.

While not shown herein, the catalyst zones may be separated by inert stages. The inert stages may include particulate refractory material having a relatively high thermal capacity. For example, the inert stages may include silica, alpha alumina, nickel molybdenum alumina, magnesium aluminate and combinations thereof, for example. The inert stages may be supported on a bed, such as the beds utilized for the catalyst systems or may be supported by the catalyst itself, for example.

Further, the catalyst system may be sulfided prior to contact with the input stream. For example, the catalyst system may be sulfided in situ by contacting the catalyst system with a crude feed that includes sulfur-containing compounds. Such processes may include passing gaseous hydrogen sulfide in the presence of hydrogen over the catalyst. (See, U.S. Pat. No. 5,468,372 and U.S. Pat. No. 5,688,736, which are incorporated by reference herein.)

### EXAMPLES

As used herein, Catalyst A was a commercially available conventional ULSD catalyst.

As used herein, Catalyst B was a commercially available residual catalyst having a larger pore size than the conventional ULSD catalysts.

As used herein, the input stream was diesel including 21.8 vol. % LCO and 1.45 wt. % sulfur.

The catalysts used in the examples included below were presulfided in situ prior to use.

Upon completion of the sulfiding, the experiments included feeding the input stream to a HDS unit. All reactions were run under constant conditions (570 psig, space velocity of 0.875/hr.)

### Example 1

The input stream was fed to the HDS unit containing 80 wt. % Catalyst A disposed equally in first and second catalyst zones and 20 wt. % Catalyst B disposed in a third catalyst zone. In addition, hydrogen was fed to the input stream at a rate of 1683 standard cubic feet per barrel (SCFB.) The liquid hourly space velocity was held at 0.86/hr to 0.88/hr.

The input stream entered the reactor at a first reaction temperature of about 350° C., which was held for 6 days. The reaction temperature was then increased to a second reaction temperature of about 359° C. for 3 days. At that time, the hydrogen feed rate was increased to 2100 SCFB. The reaction temperature was then reduced to 355° C. for an additional 2 days.

### Comparative Example

The input stream was fed to the HDS unit containing Catalyst A. In addition, hydrogen was fed to the input stream at a rate of 1683 standard cubic feet per barrel (SCFB.) The liquid hourly space velocity was held at 0.86/hr to 0.88/hr.

The input stream entered the reactor at a first reaction temperature of about 350° C., which was held for 1 day. The reaction temperature was then increased to a second reaction temperature of about 353° C. for 11 days. The reaction temperature was then increased to 359° C.

The sulfur level of each Example is plotted versus time and temperature in FIG. 3.

Unexpectedly, the embodiments described herein generally result in a longer catalyst life than systems not employing the embodiments described herein. The embodiments further reduce sulfur levels by at least about 0.5 ppm, even when the input stream includes at least 21.8 wt. % LCO.

While the foregoing is directed to embodiments of the present invention, other and further embodiments of the invention may be devised without departing from the basic scope thereof and the scope thereof is determined by the claims that follow.

What is claimed is:

1. A diesel hydrotreating system comprising:
a hydrodesulfurization unit having a catalyst system disposed therein and adapted to contact an input stream with the catalyst system therein to form diesel, wherein the catalyst system comprises a first catalyst comprising a hydrodesulfurization catalyst comprising a first pore diameter and a second catalyst comprising a second pore diameter, wherein the second pore diameter is larger than the first pore diameter.

2. The system of claim 1, wherein the catalyst system comprises a first reaction zone, a second reaction zone and a third reaction zone.

3. The system of claim 2, wherein the first reaction zone comprises the second catalyst and the second and third reaction zones comprise the first catalyst.

4. The system of claim 2, wherein the first and second reaction zones comprise the first catalyst and the third reaction zone comprises the second catalyst.

5. The system of claim 2, wherein the first and third reaction zones comprise the second catalyst and the second reaction zone comprises the first catalyst.

6. The system of claim 3, wherein the catalyst system comprises from about 15 wt. % to about 25 wt. % second catalyst.

7. The system of claim 5, wherein the catalyst system comprises from about 25 wt. % to about 35 wt. % second catalyst.

8. The system of claim 1, wherein the hydrodesulfurization unit operates at a weighed average bed temperature of from about 330° C. to about 415° C.

9. The system of claim 1, wherein the second catalyst comprises a FCC pretreatment catalyst.

10. The system of claim 1, wherein the second pore diameter is at least 10% larger than the first pore diameter.

11. The system of claim 1, wherein the second pore diameter is at least 20% larger than the first pore diameter.

12. A method of removing sulfur from a hydrocarbon feedstock comprising:
supplying a hydrodesulfurization unit having a catalyst system disposed therein, wherein the catalyst system comprises a first catalyst comprising a hydrodesulfurization catalyst and a second catalyst comprising a transition catalyst;
contacting an input stream comprising a hydrocarbon feedstock with hydrogen;
introducing the input stream into the hydrodesulfurization unit;
contacting the input stream with the catalyst system to form an output comprising diesel; and
withdrawing the output from the hydrodesulfurization unit.

13. The method of claim 12, wherein the input stream is selected from light cycle gas oil, straight run diesel and combinations thereof.

14. The method of claim 12, wherein the input stream comprises sterically hindered compounds.

15. The method of claim 14, wherein the sterically hindered compounds are selected from sterically hindered sulfur compounds, sterically hindered nitrogen compounds and combinations thereof.

16. The method of claim 12, wherein the output comprises less than about 10 ppm sulfur.

17. The method of claim 12, wherein the output comprises less than about 5 ppm sulfur.

18. The method of claim 12, wherein the method results in a level of desulfuization of at least 95%.

19. The method of claim 12, wherein the input stream contacts the first catalyst prior to the second catalyst.

20. The method of claim 12, wherein the input stream contacts the second catalyst prior to the first catalyst.

21. The method of claim 12, wherein the input stream contacts the second catalyst and then contacts the first catalyst before contacting the second catalyst again.

22. The method of claim 12, wherein the output comprises a cut point that is greater than about 620° F.

23. The method of claim 12, wherein the output comprises a cut point that is from about 620° F. to about 650° F.

24. A method of hydrodesulfurization comprising:
contacting an input stream comprising sterically hindered sulfur compounds with a catalyst system to form an output stream comprising diesel and less than about 15 ppm sulfur, wherein the catalyst system is adapted to remove at least a portion of the sterically hindered sulfur compounds from the input stream.

25. The method of claim 24, wherein the diesel comprises less than about 10 ppm sulfur.

26. The method of claim 24, wherein the catalyst system comprises a first catalyst and a second catalyst, the second catalyst having a larger pore diameter than the first catalyst.

27. The method of claim 24, wherein the diesel comprises a cut point that is greater than about 620° F.
